(19) United States
(12) Patent Application Publication
(10) Pub. No.: US 2023/0005106 A1
(43) Pub. Date: Jan. 5, 2023

(54) Automated high speed image enhancement algorithm selection and application for infrared videos

(71) Applicants: Christopher Frank Buurma, Columbus, OH (US); Christoph Grein, Wheaton, IL (US)

(72) Inventors: Christopher Frank Buurma, Columbus, OH (US); Christoph Grein, Wheaton, IL (US)

(21) Appl. No.: 17/725,108

(22) Filed: Apr. 20, 2022

Related U.S. Application Data
(60) Provisional application No. 63/177,281, filed on Apr. 20, 2021.

(51) Int. Cl. G06T 5/00

(52) U.S. Cl. CPC G06T 5/002; G06T 2207/10016; G06T 2207/30168; G06T 2207/20081; G06T 2207/30252; G06T 2207/10048

(57) ABSTRACT

A method of substantially real-time image restoration of an infrared camera includes the steps of: analyzing the last X number of video frames; classifying the last X number of video frames as to the source of noise in the last X number of video frames; selecting a noise suppression transform based on the source of the noise; receiving real time video frames; correcting the real time video frames using the selected noise suppression transform.

This application claims the benefit of U.S. Provisional Application No. 63/177,281 filed Apr. 20, 2021.

### BACKGROUND OF THE INVENTION

Driving ground vehicles in heavily degraded visual environments brings significant risk to the driver and cargo since course corrections cannot be made safely without visual cues. Infrared imagery can assist in driving vehicles under such conditions since the obscuring effect of many noise sources are reduced at longer wavelengths, namely the primary loss due to scattering is suppressed and replaced by the emission of the obscurant and its opacity or extinction coefficient. However, this method alone is insufficient when the scene is too heavily degraded with a signal-to-noise ratio below 1 since even imagery in the long-wavelength infrared (LWIR) suffers from significant loss in a heavily degraded visual environment.

### SUMMARY

An exemplary method of substantially real-time image restoration of an infrared camera includes the steps of:

analyzing noise sources in video frames of degraded imagery;
using modeling and machine learning methods, developing metrics to categorize these noise sources present in the video frames of degraded imagery;
using the metrics to rapidly identify an optimal noise removal method;
using the optimal noise removal method, restoring the degraded imagery in subsequent video frames of degraded imagery to repair damage done by the noise sources;
limiting the scope of repair to ensure proper algorithm complexity for high-speed restoring of the degraded imagery.

The step of analyzing noise sources can be done on a preceding number of 120 video frames and the noise removal is done on the succeeding number of video frames. In other words, frame number 121 is enhanced based on the analysis of the preceding 120 video frames.

The exemplary method of the invention automatically selects from a range of image processing algorithms in real time based on goals set by humans. This method uses weakly supervised learning to auto-label a training set based on the quality of the image to achieve a goal. Using less than 1% human labels, the rest of the data is auto-labeled and used to train a decision making classification algorithm for image enhancement selection. The entire workflow including application of the image enhancement occurs in less than 80 ms.

The method extracts imagery in low signal-to-noise environments. Many of the noise sources and obscurants contributing to image degradation can be rapidly categorized and suppressed in near real-time by applying image processing techniques coupled with a machine learning-based classifier. The classifier is first trained through the use of supervised learning techniques applied to labeled datasets containing both human labels and a weakly supervised learning technique. The incoming imagery is initially analyzed to determine noise sources present and their loss signatures. Next, the machine learning classifier uses this data to choose the optimum image restoration technique from its available set of methods. The chosen method is then applied in near real time to incoming video frames and sub-regions of those video frames.

Detailed analysis of the noise sources present in a set of video frames reveals a variety of characteristic noise sources, each with possible suppression transforms. First, one classifies the noise type present in a short sequence of video frames using a classification technique in a supervised machine learning approach (e.g. neural networks). Each noise category can then be analyzed, and methods are adapted to replicate the representative noise in the scene for comparison to the un-degraded scene. With successful noise replication, an associated noise suppression transform can be applied to the video frames and reduce this noise significantly, letting salient parts of the image dramatically increase in contrast. With a careful implementation, language, compiler choice, and proper hardware, this entire process can be done at high speed (<80 ms). The major limitation to speed will only be in applying the noise correction transform since the classification method can be trained offline. During operation, periodic noise re-classification can be done in asynchronous with the incoming video frames, in parallel, and over longer timescales to ensure proper image enhancement transforms are applied. Between classifications, the correction transform is still applied in near real-time to the incoming video frames and the enhanced imagery displayed to the user.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a flowchart of one exemplary image enhancement method according to the invention.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application incorporates by reference U.S. Provisional Application No. 63/177,281 filed Apr. 20, 2021.

A method includes using an image restoration algorithm and classification artificial intelligence (AI) on imagery and within the required execution time to display an image. First, noise sources are analyzed in degraded imagery with special attention paid to the temporal component of the noise. Next, modeling and machine learning methods use these developed metrics to categorize these noise sources present in imagery, allowing for rapid identification of the optimal noise removal method. Next, image restoration methods are implemented so they can repair damage done by such identified noise sources. Lastly, a limited scope implementation is done to ensure proper algorithm complexity for high-speed application of these image enhancements to remain suitable for use when driving a vehicle.

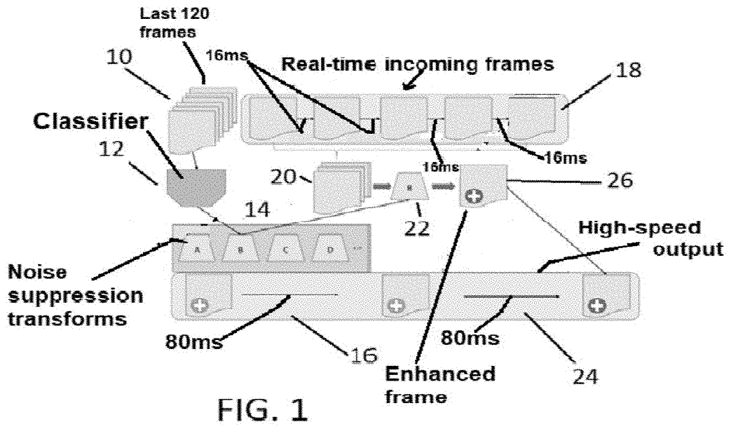

FIG. 1 illustrates this method. In step 10, the last X number of video frames, such as 120 video frames, are analyzed and classified in step 12 as to the source of noise. In step 14, an effective noise suppression transform A, B, C or D is selected based on the results of step 12. FIG. 1 shows transform B selected. The selection of the transform occurs within a short time interval 16, such as within 80 ms. In step 18, real-time incoming video frames are received and the set of video frames 20 is corrected using the selected transform in step 22, within a short interval of time 24, such as within 80 ms, resulting in an enhanced set of video frames 26.

The development of a weakly supervised learning method allowed for 0.1% of the sparsely labeled data to be used to automatically label the other 99.9% of the data based on perceived image quality and improvement after image processing for a given task. The successful training of a neural-network classifier has reached a predictive accuracy of 83% over a validation set when attempting to choose the ‘best’ image processing routine to match expected subjective human-labeled image quality. Incorrect predictions still selected highly similar methods, showing a robustness in the AI.

The invention includes wider suites of image processing functions and scenes including separate analysis of sub-regions of the image rather than only full-frame restoration methods.

Use of an exemplary embodiment of the invention can restore a full 1920×1200 14-bit frame using a 3×3 sub-region grid in 76 ms when only using 4 processing cores without GPU acceleration. This total restoration time includes the time to perform AI prediction inferences, a first restoration method, a contrast-enhancement method, and outputting the result. Images and full video sequences can be rendered using this methodology.

The method can utilize a blend of PYTHON, C, FORTRAN, and specialized compilers to achieve a balance between high extensibility and computation speed.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A method of image restoration comprising the steps of:
analyzing noise sources in video frames of degraded imagery;
using modeling and machine learning methods, developing metrics to categorize these noise sources present in the video frames of degraded imagery;
using the metrics to rapidly identify an optimal noise removal method;
using the optimal noise removal method, restoring the degraded imagery in subsequent video frames of degraded imagery to repair damage done by the noise sources;
limiting the scope of repair to ensure proper algorithm complexity for high-speed restoring of the degraded imagery to remain suitable for use when driving a vehicle.

2. The method according to claim 1, wherein the step of analyzing noise sources is done on a preceding number of 120 video frames and the noise removal is done on succeeding number of video frames.

3. A method of substantially real-time image restoration of an infrared camera includes the steps of:
analyzing the last X number of video frames;
classifying the last X number of video frames as to the source of noise in the last X number of video frames;
selecting a noise suppression transform based on the source of the noise;
receiving real time video frames;
correcting the real time video frames using the selected noise suppression transform.

4. The method of claim 3, wherein the selection of the noise suppression transform occurs within a first short time interval.

5. The method of claim 4, wherein the short time interval is about 80 ms.

6. The method of claim 5, wherein the real-time video frames are received and the real-time video frames are corrected using the selected noise suppression transform, within a second short time interval.

7. The method of claim 6, wherein the second short time interval is about 80 ms.

8. A method of substantially real-time image restoration of an infrared camera includes the steps of:
analyzing noise sources on a preceding select number of video frames and based on that analysis, removing noise on a succeeding number of video frames.

9. The method of claim 8, wherein the preceding select number of video frames comprises 120 video frames.

10. The method of claim 8, wherein the analyzing noise sources classifies the noise source from the preceding select number of video frames and based on the classification, automatically selects from a range of image processing algorithms in real time to remove noise on the succeeding number of video frames.
